(19) United States
(12) Patent Application Publication
(10) Pub. No.: US 2025/0203654 A1
(43) Pub. Date: Jun. 19, 2025

(54) CHANNEL ACCESS PROTOCOL

(71) Applicant: Cisco Technology, Inc., San Jose, CA (US)

(72) Inventors: Eric S. LIANG, San Francisco, CA (US); Juan Carlos ZUNIGA, Montreal (CA); Qihong SHAO, Clyde Hill, WA (US)

(21) Appl. No.: 18/929,315

(22) Filed: Oct. 28, 2024

Related U.S. Application Data
(60) Provisional application No. 63/612,308, filed on Dec. 19, 2023.

(51) Int. Cl. H04W 74/0808

(52) U.S. Cl. CPC H04W 74/0808

(57) ABSTRACT

The present disclosure describes a network that uses artificial intelligence to set a channel access protocol. A network device includes one or more memories and one or more processors communicatively coupled to the one or more memories. The one or more processors, individually or collectively predict, using a first machine learning model, an idle time for a wireless medium for a future period of time, predict, using a second machine learning model and based on the predicted idle time, a minimum contention window value and a maximum contention window value for the wireless medium, and wirelessly transmit an instruction to use the minimum contention window value and the maximum contention window value when communicating over the wireless medium during the period of time.

### CROSS-REFERENCE TO RELATED APPLICATIONS

This application claims benefit of co-pending U.S. provisional patent application Ser. No. 63/612,308 filed Dec. 19, 2023. The aforementioned related patent application is herein incorporated by reference in its entirety.

### TECHNICAL FIELD

Embodiments presented in this disclosure generally relate to wireless communication. More specifically, embodiments disclosed herein a wireless network that uses artificial intelligence to set a channel access protocol.

### BACKGROUND

Access points provide wireless communication access for devices over wireless mediums. When a device detects that a wireless medium is idle, the device may access and transmit messages over the medium according to a channel access protocol set by an access point. For example, when the device detects that the medium is idle, the device may wait for a certain amount of time before transmitting a message over the medium to avoid collisions. That amount of time falls within a range known as the contention window. The channel access protocol sets the contention window (e.g., using a minimum contention window value and a maximum contention window value). When the contention window is set improperly, however, collisions occur on the network, which reduces network performance.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1A illustrates an example system.

FIG. 1B illustrates an example network controller, access point, and/or device in the system of FIG. 1A.

FIG. 2 illustrates an example operation performed by the system of FIG. 1A.

FIG. 3 illustrates an example operation performed by the system of FIG. 1A.

FIG. 4 illustrates an example operation performed by the system of FIG. 1A.

FIG. 5 is a flowchart of an example method performed by the system of FIG. 1A.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

The present disclosure describes a network that uses artificial intelligence to set a channel access protocol. According to an embodiment, a network device includes one or more memories and one or more processors communicatively coupled to the one or more memories. The one or more processors, individually or collectively predict an idle time for a wireless medium for a future period of time, predict, using a machine learning model and based on the predicted idle time, a minimum contention window value and a maximum contention window value for the wireless medium, and wirelessly transmit an instruction to use the minimum contention window value and the maximum contention window value when communicating over the wireless medium during the period of time.

According to another embodiment, a method includes predicting an idle time for a wireless medium for a future period of time, predicting, using a machine learning model and based on the predicted idle time, a minimum contention window value and a maximum contention window value for the wireless medium, and wirelessly transmitting an instruction to use the minimum contention window value and the maximum contention window value when communicating over the wireless medium during the period of time.

According to another embodiment a non-transitory computer readable medium stores instructions that, when executed by one or more processors, cause the one or more processors to, individually or collectively, predict an idle time for a wireless medium for a future period of time, predict, using a machine learning model and based on the predicted idle time, a minimum contention window value and a maximum contention window value for the wireless medium, and wirelessly transmit an instruction to use the minimum contention window value and the maximum contention window value when communicating over the wireless medium during the period of time.

### Example Embodiments

The present disclosure describes a wireless network that uses artificial intelligence to determine a channel access protocol for a wireless medium. The network may predict a period of time in the future when the medium will be idle. The network then uses a machine learning model to predict a channel access protocol for that future period of time. For example, the network may use the machine learning model to predict a minimum contention window value and a maximum contention window value for that future period of time. The network then wirelessly transmits the channel access protocol to devices on the network. The devices may use the channel access protocol when accessing the wireless medium during the future period of time. The network may determine network statistics (e.g., latency, jitter, throughput, etc.) during the future period of time and update the machine learning model according to these statistics.

In certain embodiments, by using artificial intelligence to set the contention window, the network improves network performance. For example, the network may reduce collisions during the future period of time, which may improve latency, jitter, and/or throughput on the network.

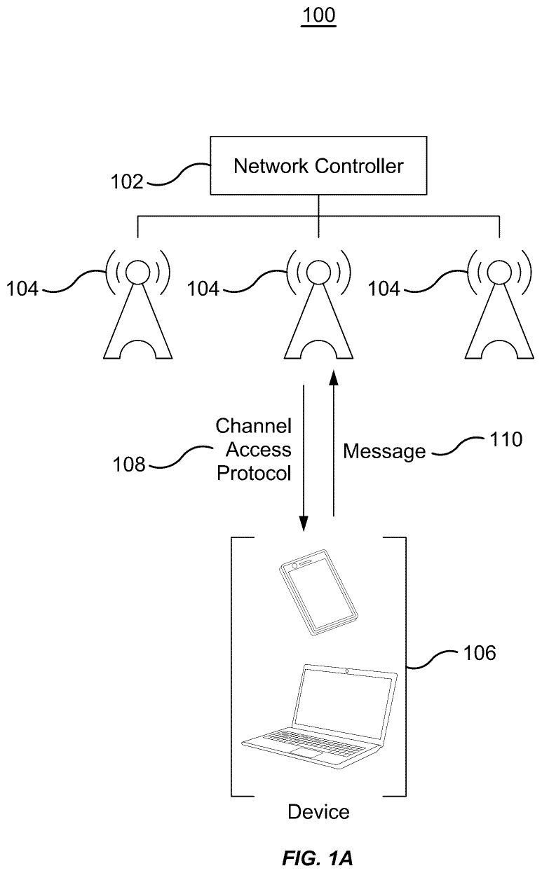

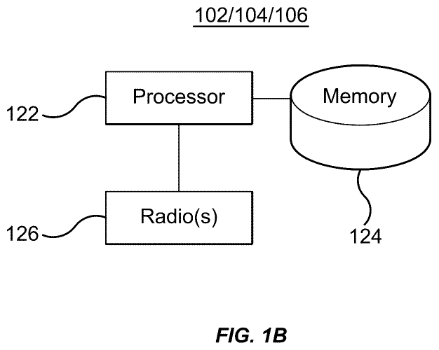

FIG. 1A illustrates an example system 100, which may be a wireless network (e.g., a Wi-Fi network). As seen in FIG. 1A, the system 100 includes one or more network devices. These network devices include one or more network controllers 102, one or more access points 104, and one or more devices 106. Generally, the network controller 102 uses artificial intelligence to predict when the wireless medium will be idle and to determine a channel access protocol for the wireless medium when the wireless medium will be idle. In this manner, the network controller 102 may improve network performance (e.g., by improving latency, jitter, throughput, etc.).

The network controller 102 facilitates or manages the communication in the system 100. The network controller 102 may instruct the access points 104 and/or device 106 to use certain communication parameters (e.g., channels, frequencies, bandwidths, transmission powers, etc.) when communicating with each other. For example, the network controller 102 may analyze historic idle times on the network and a current amount of data on the network to predict a future time when the network will be idle and can accept transmissions from the device 106. The network controller 102 uses a machine learning model to analyze network metrics (e.g., historic latency, historic jitter, historic throughput, etc.) to predict a contention window for the future time. The network controller 102 may then inform the access points 104 of the future time and the contention window to be used during the future time.

In some embodiments, the network controller 102 is integrated within one or more of the access points 104. In these implementations, the one or more access points 104 may be considered to perform the functions or features of the network controller 102. These one or more access points 104 may inform other access points 104 in the system 100 about the channel access protocols to be used at future times.

The access points 104 facilitate wireless communication (e.g., Wi-Fi communication) in the system 100. The device 106 may connect to an access point 104. The access point 104 may then facilitate wireless communication for the connected device 106. For example, the access point 104 may communicate, to the device 106, the channel access protocol 108 determined by the network controller 102. The device 106 may then transmit a message 110 to the access point 104 during the future time according to the channel access protocol 108. For example, the device 106 may transmit the message 110 to the access point 104 according to the contention window specified in the channel access protocol 108. The access point 104 may route the message 110 towards its destination.

The device 106 may be any suitable device that wirelessly connects to the access point 104. As an example and not by way of limitation, the device 106 may be a computer, a laptop, a wireless or cellular telephone, an electronic notebook, a personal digital assistant, a tablet, or any other device capable of receiving, processing, storing, or communicating information with other components of the system 100. The device 106 may be a wearable device such as a virtual reality or augmented reality headset, a smart watch, or smart glasses. The device 106 may also include a user interface, such as a display, a microphone, keypad, or other appropriate terminal equipment usable by the user. The device 106 may include a hardware processor, memory, or circuitry configured to perform any of the functions or actions of the device 106 described herein. For example, a software application designed using software code may be stored in the memory and executed by the processor to perform the functions of the device 106.

In operation, the network controller 102 uses artificial intelligence to determine the channel access protocol 108 to be used at a future time. The network controller 102 determines and uses a vector autoregression model (e.g., using Bayesian vector autoregression) to analyze the historic idle times on the network and an amount of data on the network, which may be represented as time series data. The network controller 102 uses this information to predict a future idle time on the network. The network controller 102 then uses a machine learning model (e.g., an actor-critic network(s) using reinforcement learning) to predict the channel access protocol 108 to be used during the future idle time. For example, the machine learning model may predict a minimum contention window value and a maximum contention window value to be used during the future idle time. The network controller 102 communicates the channel access protocol 108 to an access point 104, which directs the channel access protocol 108 to the device 106.

At the future time, the device 106 may detect that the network (e.g., the wireless medium) is idle. The device 106 may then wait a period of time that falls within the range bounded by the minimum contention window value and the maximum contention window value before transmitting the message 110. The device 106 may set the period of time as a random value that falls between the minimum contention window value and the maximum contention window value. By using artificial intelligence to predict the channel access protocol 108 for the future period of time, the network controller 102 may reduce collisions on the wireless medium, which improves network performance (e.g., by improving latency, jitter, throughput, etc.).

In some embodiments, the network controller 102 measures or monitors network performance during the future period of time to update or adjust the second machine learning model. For example, the network controller 102 may monitor the latency, jitter, throughput, etc. experienced on the network during the future period of time when the channel access protocol 108 is being used. If the network controller 102 determines that the network performance improved (e.g., latency and jitter reduced), then the network controller 102 may update the machine learning model by indicating to the machine learning model that the predicted channel access protocol 108 was correct, which reinforces the similar predictions moving forward. If the network controller 102 determines that the network performance did not improve (e.g., throughput reduced or latency increased), then the network controller 102 may update the machine learning model by indicating to the machine learning model that the predicted channel access protocol 108 was incorrect, which encourages the machine learning model to change future predictions.

FIG. 1B illustrates an example network controller 102, access point 104, and/or device 106 in the system 100 of FIG. 1A. As seen in FIG. 1B, the network controller 102, access point 104, and/or device 106 includes a processor 122, a memory 124, and one or more radios 126.

The processor 122 is any electronic circuitry, including, but not limited to one or a combination of microprocessors, microcontrollers, application specific integrated circuits (ASIC), application specific instruction set processor (ASIP), and/or state machines, that communicatively couples to the memory 124 and controls the operation of the network controller 102, access point 104, and/or device 106. The processor 122 may be 8-bit, 16-bit, 32-bit, 64-bit or of any other suitable architecture. The processor 122 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 122 may include other hardware that operates software to control and process information. The processor 122 executes software stored on the memory 124 to perform any of the functions described herein. The processor 122 controls the operation and administration of the network controller 102, access point 104, and/or device 106 by processing information (e.g., information received from the memory 124 and radios 126). The processor 122 is not limited to a single processing device and may encompass multiple processing devices contained in the same device or computer or distributed across multiple devices or computers. The processor 122 is considered to perform a set of functions or actions if the multiple processing devices collectively perform the set of functions or actions, even if different processing devices perform different functions or actions in the set.

The memory 124 may store, either permanently or temporarily, data, operational software, or other information for the processor 122. The memory 124 may include any one or a combination of volatile or non-volatile local or remote devices suitable for storing information. For example, the memory 124 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 124, a disk, a CD, or a flash drive. In particular embodiments, the software may include an application executable by the processor 122 to perform one or more of the functions described herein. The memory 124 is not limited to a single memory and may encompass multiple memories contained in the same device or computer or distributed across multiple devices or computers. The memory 124 is considered to store a set of data, operational software, or information if the multiple memories collectively store the set of data, operational software, or information, even if different memories store different portions of the data, operational software, or information in the set.

The radios 126 may communicate messages or information using different communication technologies. For example, the network controller 102, access point 104, and/or device 106 may use one or more of the radios 126 for Wi-Fi communications. The network controller 102, access point 104, and/or device 106 may use one or more of the radios 126 to transmit messages and one or more of the radios 126 to receive messages. The network controller 102, access point 104, and/or device 106 may include any number of radios 126 to communicate using any number of communication technologies.

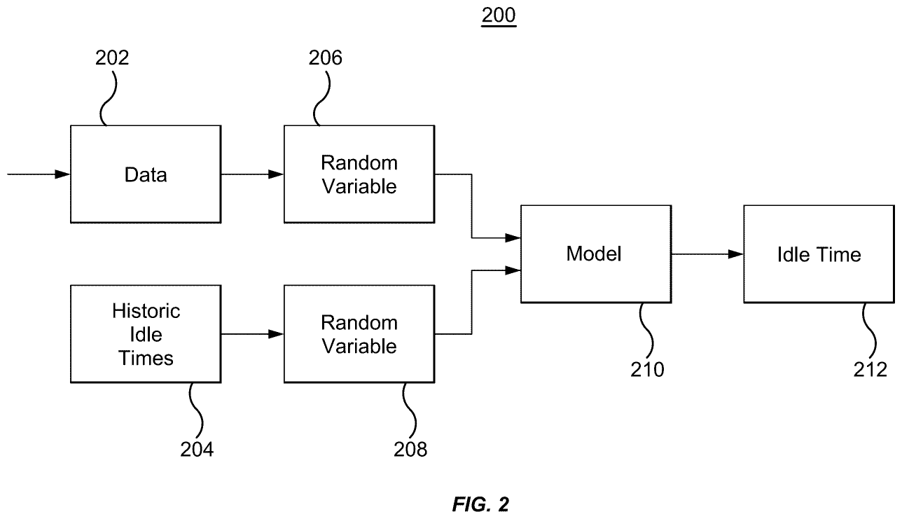

FIG. 2 illustrates an example operation 200 performed by the system 100 of FIG. 1A. In some embodiments, a network controller (e.g., the network controller 102 shown in FIG. 1A or the access point 104 shown in FIG. 1A with the network controller 102 integrated in the access point 104) performs the operation 200. By performing the operation 200, the network controller predicts a future period of time when a wireless medium is expected to be idle.

The network controller begins by determining an amount of data 202 on the wireless medium. The network controller may determine the amount of data 202 by measuring the traffic on the wireless medium. For example, individual access points may determine an amount of traffic that the access points are receiving and report this amount of traffic to the network controller. The network controller may then add these amounts of traffic to determine the amount of data 202 on the wireless medium.

The network controller may also determine historic idle times 204 on the wireless medium. For example, when the network controller determines that the wireless medium is idle, the network controller may add the idle time to a log for tracking purposes. The network controller may then refer to the log to determine the historic idle times 204 on the wireless medium. Thus, the historic idle times 204 indicate past times when the wireless medium has been idle.

The network controller treats the amount of data 202 and the historic idle times 204 as random variables 206 and 208, respectively, to determine a model 210. For example, the network controller may use Bayesian vector autoregression to determine the model 210, which may be a vector autoregression model. The model 210 may treat the amount of data 202 and the historic idle times 204 (which are fixed values) as random variables 206 and 208 with prior probabilities. For example, the network controller may use the Minnesota prior technique, which assumes that the amount of data 202 and the historic idle times 204 follow a random walk process (with or without drift). The network controller then uses the random variables 206 and 208 to determine the model 210, which models idle times on the wireless medium.

The network controller then uses the model 210 to determine an idle time 212 for the wireless medium in the future. The idle time 212 may be a period of time in the future when the network controller predicts that the wireless medium will be idle. The model 210 may model when idle times occur on the wireless medium and/or how frequently idle times occur on the wireless medium. As a result, by using the model 210, the network controller may predict when idle times may occur on the wireless medium in the future, before the idle times actually occur.

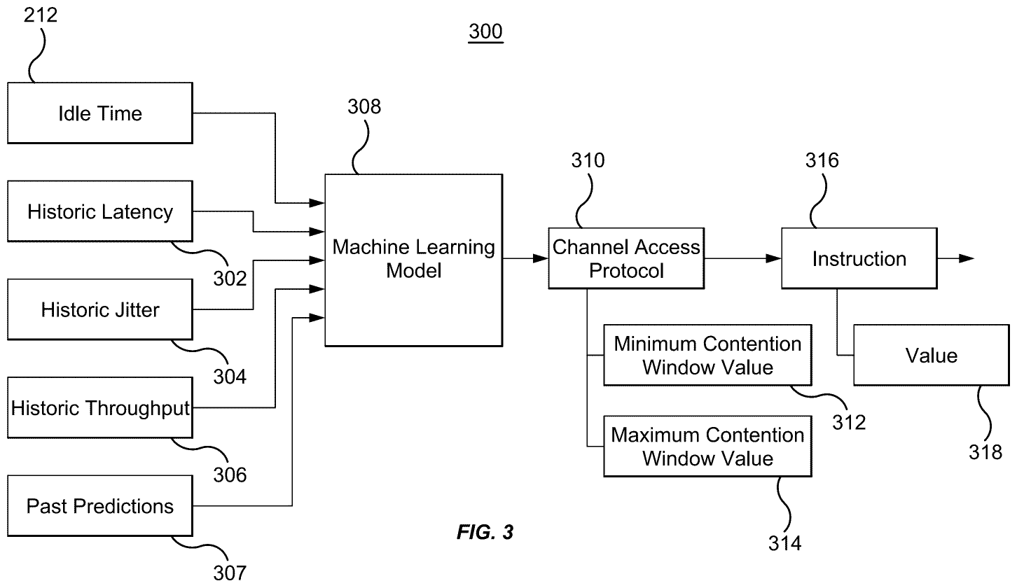

FIG. 3 illustrates an example operation 300 performed by the system 100 of FIG. 1A. In some embodiments, a network controller (e.g., the network controller 102 shown in FIG. 1A or the access point 104 shown in FIG. 1A with the network controller 102 integrated in the access point 104) performs the operation 300. By performing the operation 300, the network controller determines a channel access protocol for the predicted, future idle time.

Generally, the network controller uses artificial intelligence to predict and set the channel access protocol for the future idle time. As seen in FIG. 3, the network controller inputs the future idle time 212 predicted using the operation 200 shown in FIG. 2, historic latency 302, historic jitter 304, and historic throughput 306 into a machine learning model 308. The historic latency 302 may be time series data that indicates the latency on the wireless medium in the past. The historic jitter 304 may be time series data that indicates the jitter on the wireless medium in the past. The historic throughput 306 may be time series data that indicates the throughput over the wireless medium in the past.

The machine learning model 308 may be a reinforcement actor network that predicts a channel access protocol 310 for the wireless medium for the future idle time 212 using the historic latency 302, the historic jitter 304, and the historic throughput 306. For example, the machine learning model 308 may use this information to predict a channel access protocol 310 that is expected to reduce latency and/or jitter at the future idle time 212 and/or to increase throughput at the future idle time 212. Additionally, the machine learning model 308 may use past predictions 307 made by the machine learning model 308 to predict the channel access protocol 310 for the future idle time 212. The past predictions 307 may indicate the past channel access protocols predicted by the machine learning model 308 and the historic latency 302, historic jitter 304, and historic throughput 306 that resulted from the channel access protocols. The past predictions 307 may also include indications whether the past predictions 307 were accurate or good predictions or inaccurate or bad predictions. The machine learning model 308 may be encouraged to continue to make accurate or good predictions and to refrain from making inaccurate or bad predictions. In this manner, the machine learning model 308 implements a reinforcement framework that guides future predictions.

As an example, the machine learning model 308 may determine from the historic latency 302, the historic jitter 304, the historic throughput 306, and the past predictions 307, the characteristics of the channel access protocol that would reduce latency and jitter at the future idle time 212. The machine learning model 308 then predicts the channel access protocol with these characteristics. The machine learning model 308 may also predict the latency, jitter, and/or throughput that may result from using the channel access protocol 310 at the future idle time 212. In the example of FIG. 3, the machine learning model 308 predicts a minimum contention window value 312 and a maximum contention window value 314 for the future idle time 212. As discussed previously, the minimum contention window value 312 and the maximum contention window value 314 establish the bounds for the time range that a device uses to determine how long to wait before transmitting over an idle wireless medium. The machine learning model 308 may determine from the historic latency 302, the historic jitter 304, the historic throughput 306, and the past predictions 307, past predicted minimum contention window values and the maximum contention window values that reduced latency, reduced jitter, and/or increased throughput. The machine learning model 308 may analyze this information to determine the minimum contention window value 312 and the maximum contention window value 314 to be used during the future idle time 212. The network controller may expect that the minimum contention window value 312 and the maximum contention window value 314 will reduce latency, reduce jitter, and/or increase throughput during the future idle time 212.

In some embodiments, another machine learning model provides the past predictions 307 along with the indications of whether the past predictions 307 were accurate or inaccurate. For example, a reinforcement critic network may assess the past predictions 307 and determine the latency, jitter, and/or throughput that resulted from the past predictions 307. The critic network may then determine whether the past predictions 307 should be encouraged or discouraged moving forward based on whether the latency, jitter, and/or throughput improved. The critic network then passes these results to the machine learning model 308 to update the machine learning model 308 and to improve the performance of the machine learning model 308.

The network controller generates an instruction 316 that indicates the channel access protocol 310. For example, the instruction 316 may indicate the minimum contention window value 312 and the maximum contention window value 314 to be used at the future time when the wireless medium is predicted to be idle. The network controller then communicates the instruction 316 to other components in the network, such as access points. The access points may then forward the instruction 316 and/or the channel access protocol 310 to connected devices. The devices may then use the channel access protocol (e.g., the minimum contention window value 312 and the maximum contention window value 314) if the devices detect that the wireless medium is idle during the future time.

In some embodiments, the network controller adds a value 318 to the instruction 316 that indicates that the machine learning model 308 was used to predict the channel access protocol 310. For example, the value 318 may be a unique value or an identifier value used by the network controller or by the machine learning model 308. By including the value 318 in the instruction 316, the access points and devices in the network may be assured that the channel access protocol 310 in the instruction 316 was predicted by the machine learning model 308.

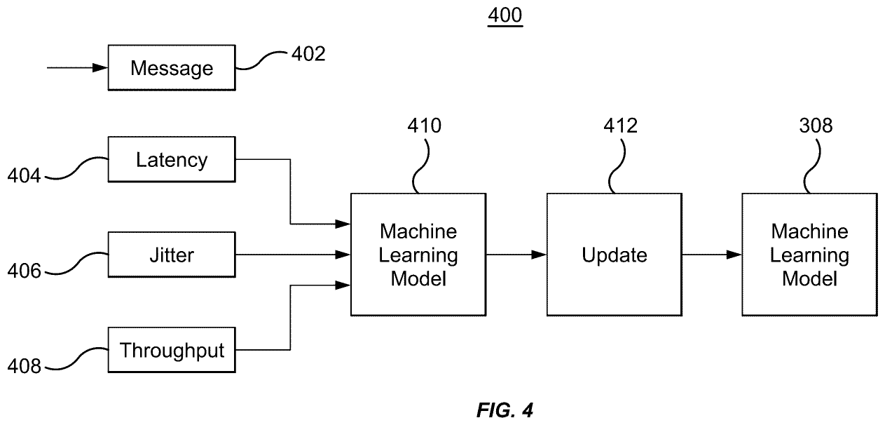

FIG. 4 illustrates an example operation 400 performed by the system 100 of FIG. 1A. In some embodiments, a network controller (e.g., the network controller 102 shown in FIG. 1A or the access point 104 shown in FIG. 1A with the network controller 102 integrated in the access point 104) performs the operation 400. By performing the operation 400, the network controller updates the machine learning model used to predict the channel access protocol.

The network controller begins by receiving a message 402. A device may have transmitted the message 402 over the wireless medium during the predicted future idle time when the predicted channel access protocol was used. The network controller may determine the latency 404, jitter 406, and throughput 408 of the wireless medium during the message 402 transmission. The latency 404, jitter 406, and throughput 408 may indicate a performance of the network using the predicted channel access protocol.

The network controller inputs the latency 404, jitter 406, and throughput 408 into a machine learning model 410, which may be a reinforcement critic network. In some embodiments, the machine learning model 410 is part of the machine learning model 308. The machine learning model 410 analyzes the latency 404, jitter 406, and throughput 408 to determine whether the predicted channel access protocol improved network performance and/or provided satisfactory network performance. The machine learning model 410 may then determine an update 412 to the machine learning model 308 based on whether the predicted channel access protocol improved and/or provided satisfactory network performance. For example, if the predicted channel access protocol reduced network performance, the machine learning model 410 may determine the update 412 to discourage the machine learning model 308 from making the same predictions in the future. As a result, the update 412 functions as a punishment for the machine learning model 308. If the predicted channel access protocol improved network performance, the machine learning model 410 may determine the update 412 to encourage the machine learning model 308 to make the same predictions in the future. As a result, the update 412 functions as a reward for the machine learning model 308. In some embodiments, the update 412 also includes changes to the machine learning model 308 to improve the predictions made by the machine learning model 308 in the future. For example, the update 412 may include changes to weights used by the machine learning model 308 (e.g., weights that affect the influence of historic latency, historic jitter, and/or historic throughput on the predicted channel access protocol). The network controller communicates applies the update 412 to the machine learning model 308 to update or adjust the machine learning model 308.

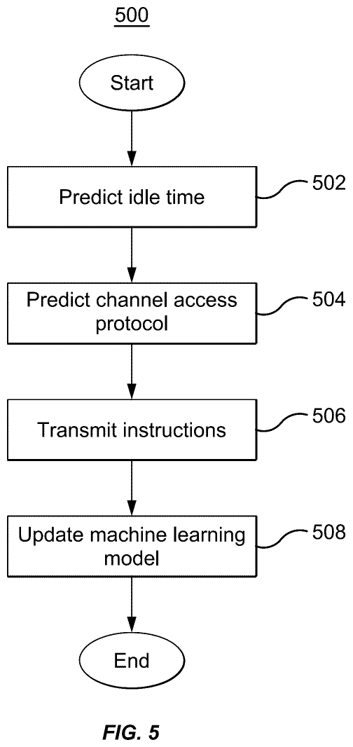

FIG. 5 is a flowchart of an example method 500 performed by the system 100 of FIG. 1A. In certain embodiments, a network device (e.g., the network controller 102 shown in FIG. 1A or the access point 104 shown in FIG. 1A with the network controller 102 integrated in the access point 104) performs the method 500. By performing the method 500, the network device predicts a channel access protocol to be used at a future idle time.

At 502, the network device predicts an idle time that is expected to occur in the future. The network device may determine a model (e.g., a Bayesian vector autoregression model) that models idle times in time. The network device may analyze historic idle times on a wireless medium to determine the model. For example, the network device may treat the historic idle times as random variables rather than fixed values to model the idle times that may occur in the future.

At 504, the network device predicts a channel access protocol for the predicted, future idle time. For example, the network device may use a first machine learning model (e.g., a reinforcement actor network) to analyze historic latency, historic jitter, historic throughput, etc. to predict a channel access protocol that is expected to improve or provide satisfactory network performance during the future idle time. The machine learning model may predict the channel access protocol, including a minimum contention window value and a maximum contention window value. At 506, the network device transmits instructions to communicate the predicted channel access protocol. For example, the network device may use the instructions to communicate the predicted channel access protocol to access points in the network. The access points may then communicate the predicted channel access protocol to connected devices, and the devices may use the channel access protocol during the future idle time.

At 508, the network device updates the first machine learning model. For example, the network device may measure network performance (e.g., latency, jitter, throughput) during the future time. The network device may input the measured metrics into a second machine learning model (e.g., a reinforcement critic network) that determines how to provide feedback to the first machine learning model. The feedback may adjust the first machine learning model to make similar predictions moving forward or to refrain from making similar predictions moving forward. Additionally, the update may indicate adjustments to the first machine learning model (e.g., adjustments to weights of the first machine learning model).

In summary, the wireless network uses artificial intelligence to determine a channel access protocol for a wireless medium. The network may predict a period of time in the future when the medium will be idle. The network then uses a machine learning model to predict a channel access protocol for that future period of time. For example, the network may use the machine learning model to predict a minimum contention window value and a maximum contention window value for that future period of time. The network then wirelessly transmits the channel access protocol to devices on the network. The devices may use the channel access protocol when accessing the wireless medium during the future period of time. The network may determine network statistics (e.g., latency, jitter, throughput, etc.) during the future period of time and update the machine learning model according to these statistics.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A network device comprising:
one or more memories; and
one or more processors communicatively coupled to the one or more memories, the one or more processors configured to, individually or collectively:
predict an idle time for a wireless medium for a future period of time;
predict, using a machine learning model and based on the predicted idle time, a minimum contention window value and a maximum contention window value for the wireless medium; and
wirelessly transmit an instruction to use the minimum contention window value and the maximum contention window value when communicating over the wireless medium during the period of time.

2. The network device of claim 1, wherein the idle time is predicted based on an amount of data on the wireless medium and historical idle times for the wireless medium.

3. The network device of claim 2, wherein predicting the idle time comprises determining a vector autoregression model based on the amount of data on the wireless medium and the historical idle times for the wireless medium.

4. The network device of claim 1, wherein the minimum contention window value and the maximum contention window value are predicted based on at least one of historical latency on the wireless medium, historical jitter on the wireless medium, or historical throughput on the wireless medium.

5. The network device of claim 1, wherein the one or more processors are configured to, individually or collectively:
determine a latency, a jitter, and a throughput for the wireless medium during the period of time; and
update the machine learning model based on the determined latency, jitter, and throughput.

6. The network device of claim 1, wherein the instruction comprises a value indicating that the machine learning model was used to predict the minimum contention window value and the maximum contention window value for the wireless medium.

7. The network device of claim 1, wherein the minimum contention window value and the maximum contention window value for the wireless medium indicate bounds for a period of time to wait before transmitting over the wireless medium after detecting that the wireless medium is idle.

8. A method comprising:
predicting an idle time for a wireless medium for a future period of time;
predicting, using a machine learning model and based on the predicted idle time, a minimum contention window value and a maximum contention window value for the wireless medium; and
wirelessly transmitting an instruction to use the minimum contention window value and the maximum contention window value when communicating over the wireless medium during the period of time.

9. The method of claim 8, wherein the idle time is predicted based on an amount of data on the wireless medium and historical idle times for the wireless medium.

10. The method of claim 9, wherein predicting the idle time comprises determining a vector autoregression model based on the amount of data on the wireless medium and the historical idle times for the wireless medium.

11. The method of claim 8, wherein the minimum contention window value and the maximum contention window value are predicted based on at least one of historical latency on the wireless medium, historical jitter on the wireless medium, or historical throughput on the wireless medium.

12. The method of claim 8, further comprising:
determining a latency, a jitter, and a throughput for the wireless medium during the period of time; and
updating the machine learning model based on the determined latency, jitter, and throughput.

13. The method of claim 8, wherein the instruction comprises a value indicating that the machine learning model was used to predict the minimum contention window value and the maximum contention window value for the wireless medium.

14. The method of claim 8, wherein the minimum contention window value and the maximum contention window value for the wireless medium indicate bounds for a period of time to wait before transmitting over the wireless medium after detecting that the wireless medium is idle.

15. A non-transitory computer readable medium storing instructions that, when executed by one or more processors, cause the one or more processors to, individually or collectively:
predict an idle time for a wireless medium for a future period of time;
predict, using a machine learning model and based on the predicted idle time, a minimum contention window value and a maximum contention window value for the wireless medium; and
wirelessly transmit an instruction to use the minimum contention window value and the maximum contention window value when communicating over the wireless medium during the period of time.

16. The medium of claim 15, wherein the idle time is predicted based on an amount of data on the wireless medium and historical idle times for the wireless medium.

17. The medium of claim 16, wherein predicting the idle time comprises determining a vector autoregression model based on the amount of data on the wireless medium and the historical idle times for the wireless medium.

18. The medium of claim 15, wherein the minimum contention window value and the maximum contention window value are predicted based on at least one of historical latency on the wireless medium, historical jitter on the wireless medium, or historical throughput on the wireless medium.

19. The medium of claim 15, wherein the instructions further cause the one or more processors to, individually or collectively:
determine a latency, a jitter, and a throughput for the wireless medium during the period of time; and
update the machine learning model based on the determined latency, jitter, and throughput.

20. The medium of claim 15, wherein the instruction comprises a value indicating that the machine learning model was used to predict the minimum contention window value and the maximum contention window value for the wireless medium.
